(19) United States
(12) Patent Application Publication
(10) Pub. No.: US 2002/0155758 A1
(43) Pub. Date: Oct. 24, 2002

(54) Electric connector having at least one port

(76) Inventor: Chun Ching Wang, Taipei (TW)

Correspondence Address: Chun Ching Wang, 235 Chung - Ho, Box 8-24, Taipei, TW

(21) Appl. No.: 10/054,397

(22) Filed: Jan. 24, 2002

(30) Foreign Application Priority Data
Apr. 19, 2001 (TW) 090206194

(51) Int. Cl. H01R 13/66

(52) U.S. Cl. 439/620

(57) ABSTRACT

An electric connector having at least one port includes a casing having at least one port, at least one terminal seat, and at least one circuit board having a plurality of electronic elements thereon. Each terminal seat includes a first terminal seat half and a second terminal seat half. Each terminal seat has a plurality of conductive terminals. The circuit board has holes to be connected with a first terminal seat half and a second terminal seat half of the terminal seat. The terminals of the first terminal seat half serve to receive signals. The terminals of the second terminal seat half serves to be connected to a device end. By connecting the holes to the terminals and then combing the terminal seat halves and the circuit board, the terminals are electrically conducted with the electronic elements on the circuit board. Further. plastics or rubber is filled to the outer sides of the circuit board and the elements; and then the terminal seat with the circuit board is inserted into the casing.

### FIELD OF THE INVENTION

The present invention relates to a connector, and particularly to an electric connector having at least one port which can suffer from a very larger pulling or inserting force. Moreover, each terminal seat of the connector can be detached individually for updating or repairing.

### BACKGROUND OF THE INVENTION

Since the development of electronic science, the communication devices, networks, and computers become more and more complex. Furthermore, in the high frequency transmission, transformers, filters, and other electronic elements are necessary for isolating or deleting signals so as to have a preferred communication quality. For example, Taiwan Patent No. 347153 discloses a connector which is attached by electronic elements, thereby, deleting noises during signal transmission process. In that patent, the electronic element 101 (referring to FIG. 2) is welded to a circuit board 10 (referring to FIG. 1). The circuit board 10 is formed with holes 12 at positions to be connected to a terminal seat 11. Thereby, the pins 13 of the terminal seat 12 are tightly engaged to the holes 12 of the circuit board 10. Furthermore, the golden fingers 14 on the circuit board 10 are conducted to the terminals 15 by contact. The connection in this prior art is very simple and thus is unstable. Especially, since the terminal 15 is conducted to the circuit board 10 by contact. A little vibration of the connector will possibly cause a poor transmission between the terminals and the circuit board. With reference to FIG. 2, as this prior connector is used in a multi-port electric connector, each terminal seat 11 is inserted into a respective port 16 one by one and then plastics or rubber 17 is filled around the outer side for positioning the two components. The disadvantage of this way is that when the contact between the terminal seat 11 and circuit board 10 is not preferred, the terminal seat 11 can not be taken out for being repaired. Thereby, the whole multi-port electric connector must be deserted. Further, since a large force is necessary to insert or pull the connector, if the contact between the terminals 15 and the circuit board 10 is unstable, it is very possible the contact therebetween become weak so as to affect the signal transmission quality.

### SUMMARY OF THE INVENTION

Accordingly, the primary object of the present invention is to provide an electric connector, wherein the multi-port electric connector can suffer from a very larger pulling or inserting force. Moreover, in the present invention, each terminal seat can be detached individually for updating or repairing.

To achieve the object, the present invention provides a electric connector having at least one port comprising a casing having at least one port, at least one terminal seat capable of being inserted into the port in the casing, and at least one circuit board connected to the terminal seat and having a plurality of electronic elements thereon.

Each terminal seat includes a first and second terminal seat halves. Each of the terminal seat halves includes a plurality of conducting terminals. The circuit board is formed with holes at positions to be connected to the plurality of terminals of the first and second terminal seat halves, respectively. By connecting the holes to the terminals and then combing the terminal seat halves and the circuit board, the terminals are electrically conducted with the circuits on the circuit board. When the connection of the circuit board and the terminal seat halves is completed, plastics or rubber is filled into the outer side of the circuit board and the elements to enclose the circuit board and the elements. Thereby, the structure becomes more stable.

The various objects and advantages of the present invention will be more readily understood from the following detailed description when read in conjunction with the appended drawing.

### BRIEF DESCRIPTION OF THE DRAWINGS

FIG. 1 shows the connection of the terminal seat of a prior connector and a circuit board.

FIG. 2 is a perspective view of a prior multi-port electric connector.

FIG. 3 shows the connection of the terminal seat of the connector of the present invention and a circuit board.

FIG. 4 is a perspective view of the electric connector of the present invention.

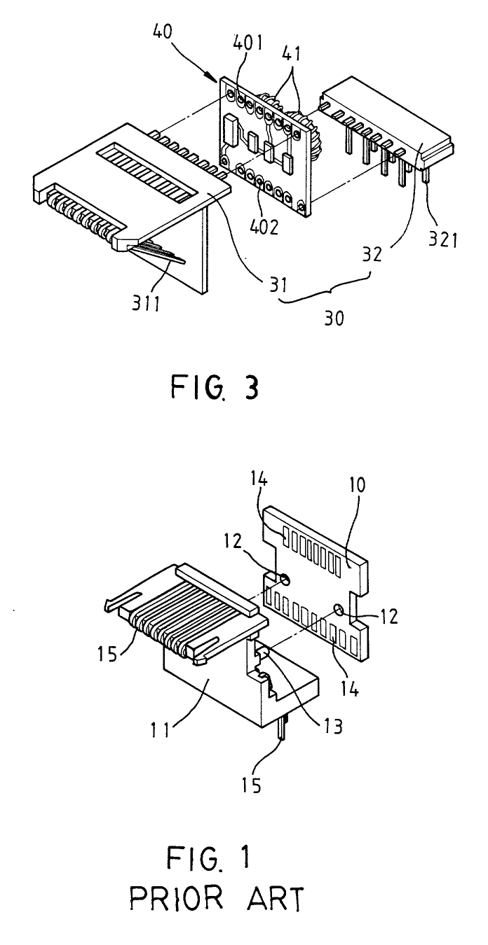

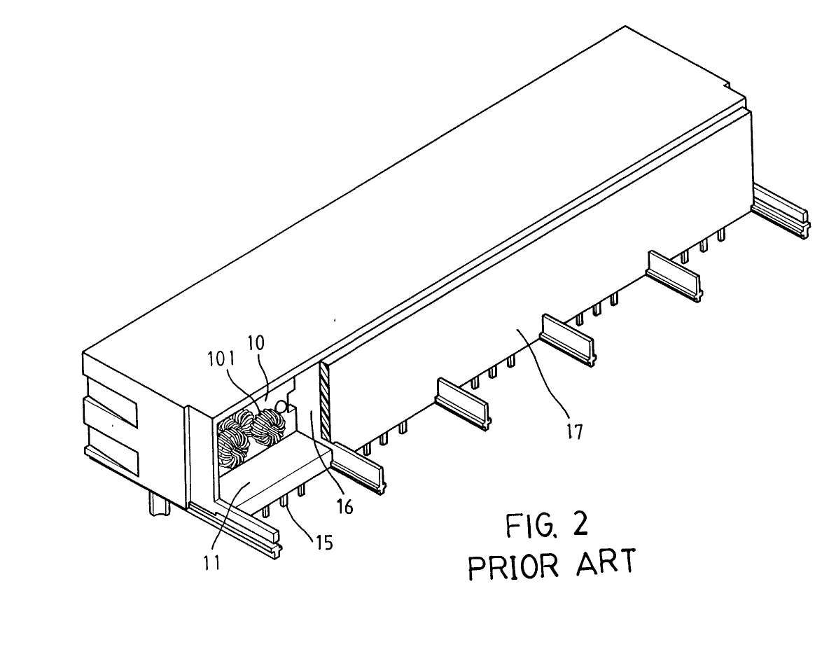

### DETAILED DESCRIPTION OF THE PREFERRED EMBODIMENTS

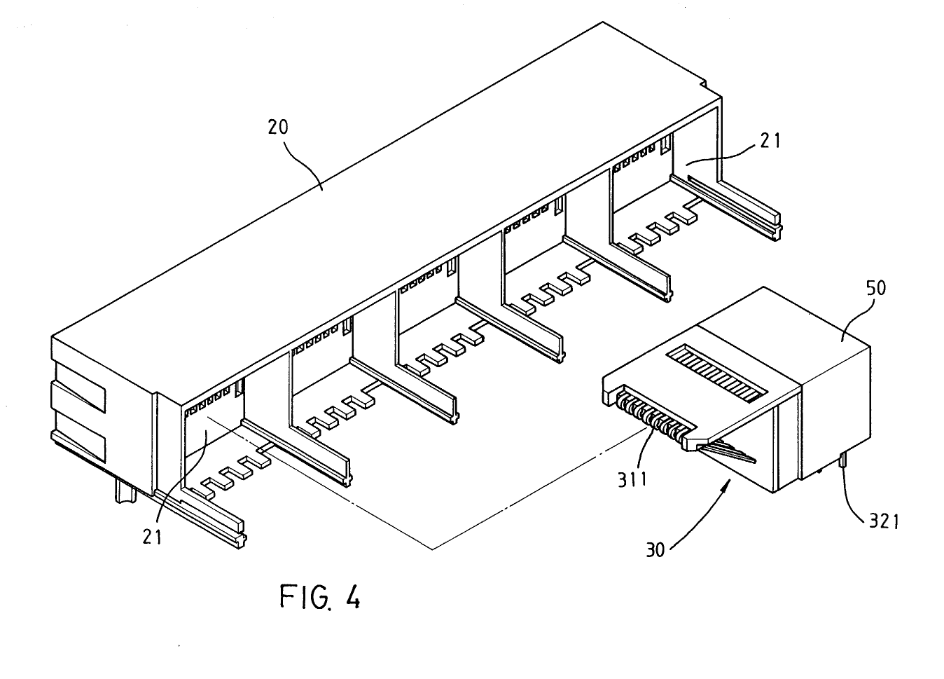

Referring to FIGS. 3 and 4, the electric connector having at least one port of the present invention is illustrated. The connector includes a casing 20 having a plurality of ports 21. The ports 21 can be inserted by a plurality of terminal seats. Each port 21 of the multi-port electric connector is suitable to a terminal seat 30 and is connected to a circuit board 40 having electronic elements 41 on the circuit board 40. Referring to FIG. 3, each terminal seat 30 includes a first and second terminal seat halves 31, and 32. Each of the terminal seat halves 31 and 32 includes a plurality of conducting terminals 311, 321. The terminals 311 of the first terminal seat half 31 serve to receive signals. The terminal 321 of the second terminal seat half 32 are connected to a device end (in general, it is welded to a machine board). The circuit board 40 serves to communicate the signal end with the device end.

The circuit board 40 is formed with holes 401, 402 at positions to be connected to the plurality of terminals 311, 321 of the first and second terminal seat halves 31, and 32, respectively. By connecting the holes 401 and 402 to the terminals 311 and 321 and then combing the terminal seat halves 31, 32 and the circuit board 40 (in general, by welding), the terminals 311, 321 are electrically conducted with the electronic elements on the circuit board 40. When the connection of the circuit board 40 and the terminal seat halves 31 and 32 are complete, plastics or rubber is filled into the outer side of the circuit board 40 and the element 41 to enclose the circuit board 40 and the elements 41. Thereby, the structure becomes more stable. With reference to FIG. 4, it is shown that an assembled terminal seat 30 is inserted into the port 21 in the casing 20.

It is noted that in above multi-port electric connector, each of the terminals 311, 321 can be firmly secured to the circuit board 40.

What is claimed is:

1. An electric connector having at least one port, the electric connector comprising a casing having at least one port, at least one terminal seat capable of being inserted into the port in the casing, and at least one circuit board connected to the terminal seat and having a plurality of electronic elements thereon; each terminal seat including a first terminal seat half and a second terminal seat half; each terminal seat having a plurality of conductive terminals; wherein the circuit board has holes at positions to be connected with a first terminal seat half and a second terminal seat half, respectively; wherein by connecting the holes to the terminals and then combing the terminal seat halves and the circuit board, the terminals are electrically conducted with the electronic elements on the circuit board; then, plastics or rubber is filled around outer sides of the circuit board and the electronic elements; and then the terminal seat with the circuit board is inserted into the casing.

2. The electric connector having at least one port as claimed in claim 1, wherein a plurality of ports are formed on the casing.
